(19) United States
(12) Patent Application Publication
(10) Pub. No.: US 2011/0119410 A1
(43) Pub. Date: May 19, 2011

(54) SERVER SYSTEM

(75) Inventors: Chih-Wei CHEN, TAIPEI CITY (TW); Hsiao-Fen LU, TAIPEI CITY (TW)

(73) Assignee: INVENTEC CORPORATION, TAIPEI CITY (TW)

(21) Appl. No.: 12/687,884

(22) Filed: Jan. 15, 2010

(30) Foreign Application Priority Data
Nov. 18, 2009 (TW) 98139181

(51) Int. Cl. G06F 3/00; G06F 13/00

(52) U.S. Cl. 710/19; 710/107

(57) ABSTRACT

A server system is provided. The server system includes a baseboard and a plurality of motherboards. The baseboard includes a baseboard management controller (BMC). The motherboards are connected to the baseboard. Each of the motherboards comprises at least one sensor and a signal-processing unit. The sensor is used to sense a status of the motherboard. The signal-processing unit is used to update a status record according to the sensor. The signal-processing unit further transmits the status record to the BMC. The BMC transmits a control signal to the signal-processing unit to control the sensor through the signal-processing unit according to the status record.

### RELATED APPLICATIONS

This application claims priority to Taiwan Application Serial Number 98139181, filed Nov. 18, 2009, which is herein incorporated by reference.

### BACKGROUND

1. Field of Invention

The present invention relates to a system for processing digital signals. More particularly, the present invention relates to a server system.

2. Description of Related Art

A server system generally needs to be connected to various motherboards, and processes the signals on the respective motherboards. In general, a motherboard has an independent system management chip, such as a baseboard management controller (BMC), to manage the motherboard sensors. A concentrated management chip is further disposed on the server. No matter the BMC or the concentrated management chip, the manufacturing cost is extremely high. In addition, the BMCs manufactured by different companies typically have different processing instructions in different specifications thereby complicating the program design applied to the concentrated management chip. Once the sensor of the motherboard has to be modified, the modification thereof causes a lot of bothers.

Hence, it is an important topic for those in this industry to develop a novel server system for monitoring various motherboards with lower cost.

### SUMMARY

An aspect of the present invention is to provide a server system that includes a baseboard and a plurality of motherboards. The baseboard includes a baseboard management controller. The motherboards are connected to the baseboard. Each of the motherboards includes at least one sensor and a signal-processing unit. The at least one sensor is used to sense a status of the motherboard. The signal-processing unit is used to update a status record according to the at least one sensor. The signal-processing unit is used to transmit the status record to the baseboard management controller, and the baseboard management controller is used to transmit a control signal to the signal-processing unit for controlling the at least one sensor through the signal-processing unit according to the status record.

In one embodiment, the signal-processing unit is a peripheral interface controller (PIC).

In another embodiment, the signal-processing unit communicates with the baseboard management controller through an inter-Integrated circuit (I²C) interface.

In another embodiment, the control signal is in an intelligent platform management bus specification.

In another embodiment, the signal-processing unit includes a non-volatile random access memory (NVRAM) used to store the status record.

In another embodiment, the control signal is used to retrieve the status record, to set a parameter on the sensor, to retrieve a model parameter of the sensor, or to switch the sensor.

In another embodiment, the sensor is a temperature sensor, a fan-speed sensor, or a voltage sensor.

In another embodiment, the baseboard management controller communicates with a remote host via a network, thereby enabling the remote host to control the baseboard management controller.

An aspect of the present invention is used to provide a server system that includes a baseboard, a first motherboard and a second motherboard. The baseboard includes baseboard management controller on the baseboard. The first motherboard connected to the baseboard includes at least one first sensor and signal-processing unit. The first sensor is used to sense a status of the first motherboard. The signal-processing unit is used to update a first status record according to the at least one first sensor. The second motherboard connected to the baseboard includes at least one second sensor and a baseboard management controller on the motherboard. The at least is one second sensor is used to sense a status of the at least one second motherboard. The baseboard management controller on the motherboard is to used update a second status record according to the at least one second sensor. The baseboard management controller on the baseboard is used to transmit a control signal to the signal-processing unit and the baseboard management controller on the motherboard for controlling the at least one first sensor and the at least one second sensor via the signal-processing unit and the baseboard management controller on the motherboard respectively. The first status record and the second status record are further transmitted to the baseboard management controller on the baseboard by the signal-processing unit and the baseboard management controller on the motherboard.

In one embodiment, the signal-processing unit is a peripheral interface controller (PIC). The signal-processing unit and the baseboard management controller on the motherboard communicate with the baseboard management controller on the baseboard via an inter-integrated circuit (I²C) interface. The control signal is in an intelligent platform management bus specification.

The embodiments of the present invention have the advantages of disposing the signal-processing unit on the motherboard to process the signal thereby central controlling by the baseboard management controller on the baseboard such that the manufacturing cost of the motherboards can be lowered without designing different programs for different motherboards to control the sensors.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram showing a server system according to an embodiment of the present invention; and

FIG. 2 is a block diagram showing a server system according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

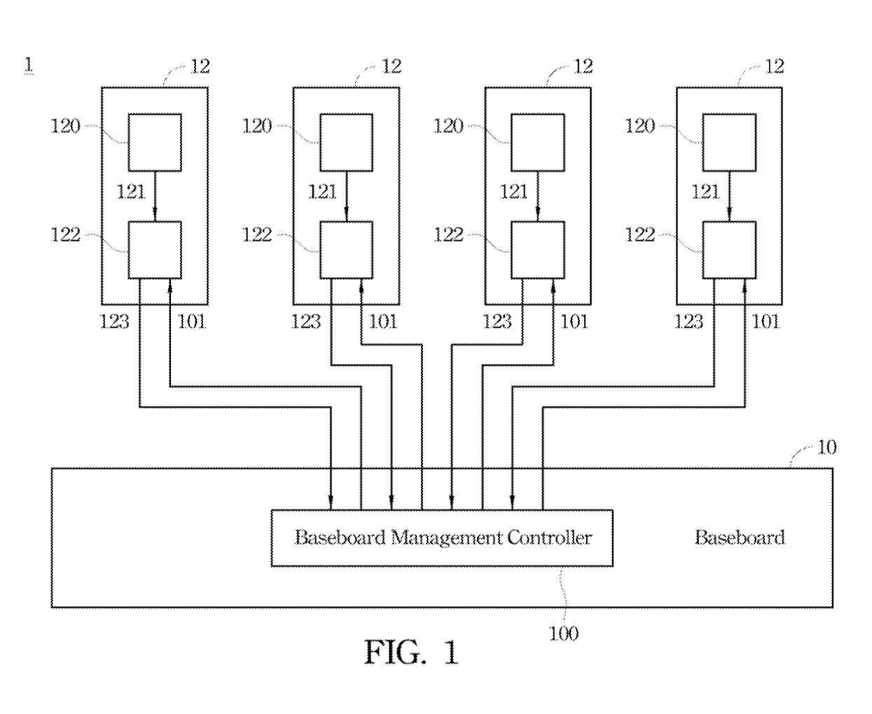

Referring to FIG. 1, FIG. 1 is a block diagram showing a server system 1 according to an embodiment of the present invention. The server system 1 includes a baseboard 10 and a plurality of motherboards 12.

The baseboard 10 includes baseboard management controller 100 supporting the intelligent platform management interface (IPMI) architecture for transmitting or receiving signals.

The motherboards 12 are connected to the baseboard 10. In the present embodiment, there are four motherboards all numbered 12 in FIG. 1. However, the amount of the motherboards connected to the baseboard could is be adjusted in other embodiments. Each of the motherboards 12 includes at least one sensor 120 and a signal-processing unit 122. The sensor 120 is used to sense a status of one of the motherboards 12. In different embodiments, the sensor 12 can be a temperature sensor used to sense the temperature of one of the motherboards 12, a fan-speed sensor used to sense the fan speed of one of the motherboards 12, a voltage sensor used to sense the voltage of the server system 1, thereby retrieving a state 121 typically expressed in numbers.

The signal-processing unit 122 is used to update a status record 123 according to the state 121 sensed by the sensor 120. In one embodiment, the signal-processing unit 122 is a peripheral interface controller (PIC) module, i.e. an unsophisticated circuit structure acted as a chip for mainly controlling the signal transmission between peripheral devices and a host. In one embodiment, the signal-processing unit 122 includes a non-volatile random access memory (NVRAM) used to store a status record 123. Therefore, after the sensor 120 senses a status of the motherboard 12, the signal-processing unit 122 receives the state 121 from the sensor 120 to update the status record 123 with time.

The signal-processing unit 122 is further used to transmit the status record 123 to the baseboard management controller 100 such that the baseboard management controller 100 obtains information of the states 121. Therefore, the baseboard management controller 100 transmits a control signal 101 to the signal-processing unit 122 according to the status record 123 thereby controlling the sensor 120 by the signal-processing unit 122. In one embodiment, the communication between the signal-processing unit 122 and is the baseboard management controller is performed by an inter-Integrated circuit (I²C) interface. The I²C interface supports intelligent platform management bus specification. Hence, the control signal 101 is a signal in an intelligent platform management bus specification. The control signal 101 controls the sensor 120 to retrieve the status record 123, to set a parameter on the sensor 120, to retrieve a model parameter of the sensor 120, or to switch the sensor 120. The baseboard management controller 100 can retrieve information from sensor 120 through the signal-processing unit 122 according to the control signal 101 so as to further control and adjust the sensor 120.

In one embodiment, the baseboard management 100 communicates with a remote host (not shown) such that the remote host can obtain the states of the sensor 120 to control the baseboard management controller 100. The remote host can communicate with the baseboard management controller 100 via a network interface.

In the server system 1 of the above embodiment, the signal-processing unit 122 disposed on the motherboard 12 is used to process the signal only. The function that the signal-processing unit 122 has to provide is to read the control signal 101 transmitted from the baseboard management controller 100 and to be controlled by the baseboard management controller 100 disposed on the baseboard 10 thereby not only lowering the manufacturing cost but also controlling the sensor 120 without designing different program for the motherboards 12 of different models or manufactured by different companies.

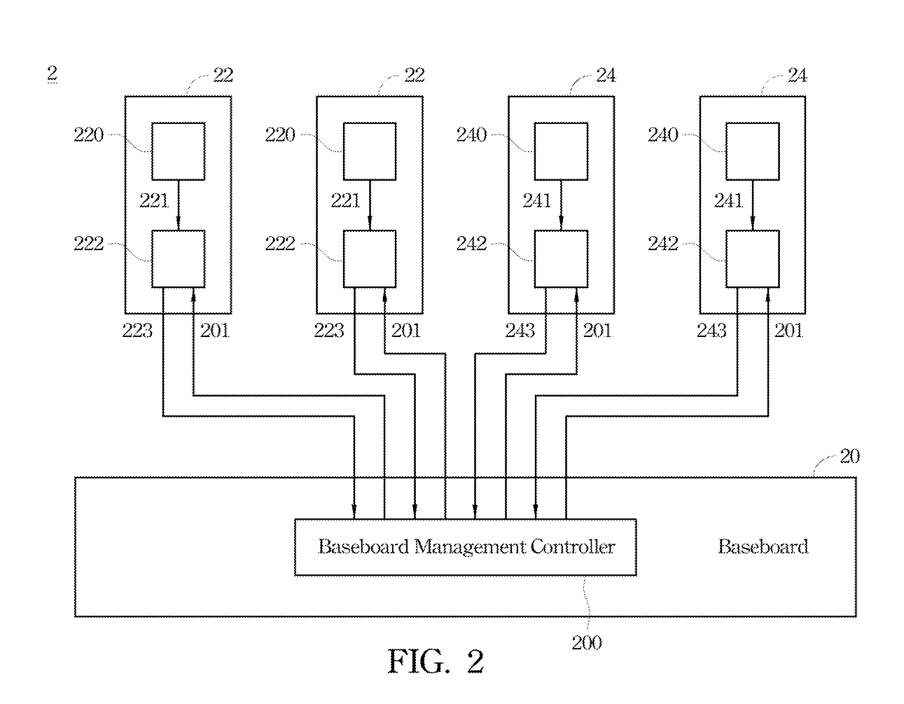

Referring to FIG. 2, FIG. 2 is a block diagram showing a server system 2 according to another embodiment of the present invention. The server system 2 includes a baseboard 20, first motherboards 22 and second motherboards 24. The baseboard 20 includes baseboard management controller 200 on the baseboard 20. The first motherboards 22 are connected to the baseboard 20. Each of the first motherboards 22 includes a first sensor 220 and a signal-processing unit 222. The first sensor 220 and the signal-processing unit 122 are identical to the sensor 120 and the signal-processing unit 122 of FIG. 1. The first sensor 220 is used to sense the first motherboard 22, and the signal-processing unit 222 is used to update a first status record 223 according to the state 221 sensed by the first sensor 220. There is no further statement here.

The second motherboards 24 are connected to the baseboard 20. Each of the second motherboards 24 includes a second sensor 240 and a baseboard management controller 242 on the motherboard 24. The baseboard management controller 242 on the motherboard 24 is used to update a second status record 243 according to a state 241 sensed by the second sensor 240.

The baseboard management controller 200 on the baseboard 20 is used to transmit a control signal 201 to the signal-processing unit 222 and the baseboard management controller 242 on the motherboard 24 such that the signal-processing unit 222 and the baseboard management controller 242 on the baseboard 20 can control the first sensor 220 and the second sensor 240 respectively. Furthermore, the signal-processing unit 222 and the baseboard management controller 242 on the motherboard 24 transmit the first status record 223 and the second status record 243 to the baseboard management controller 200 on the baseboard 20.

The server system 2 of the present embodiment enables the baseboard 20 not only to communicate with the first motherboard 22 on which the signal-processing unit 222 is disposed but also to communicate with the second motherboard 24 on which the baseboard management controller 242 on the motherboard 24 is disposed. Therefore, a baseboard management controller disposed on a motherboard provided by the manufacturer is also applicable to the server system 2 of the present embodiment and the application thereof is variable in use.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A server system comprising:
a baseboard comprising a baseboard management controller; and
a plurality of motherboards connected to the baseboard, each of the motherboards comprising:
at least one sensor used to sense a status of the motherboard; and
a signal-processing unit used to update a status record according to the at least one sensor,
wherein the signal-processing unit further is used to transmit the status record to the baseboard management controller, and the baseboard management controller is used to transmit a control signal to the signal-processing unit for controlling the at least one sensor through the signal-processing unit according to the status record.

2. The system of claim 1, wherein the signal-processing unit is a peripheral interface controller (PIC).

3. The system of claim 1, wherein the signal-processing unit is communicated with the baseboard management controller through an inter-Integrated circuit (I²C) interface.

4. The system of claim 1, wherein the control signal is in an intelligent platform management bus specification.

5. The system of claim 1, wherein the signal-processing unit comprises a non-volatile random access memory used to store the status record.

6. The system of claim 1, wherein the control signal is used to retrieve the status record, to set a parameter on the sensor, to retrieve a model parameter of the sensor, or to switch the sensor.

7. The system of claim 1, wherein the sensor is a temperature sensor, a fan-speed sensor, or a voltage sensor.

8. The system of claim 1, wherein the baseboard management controller communicates with a remote host through a network, thereby enabling the remote host to control the baseboard management controller.

9. A server system comprising:
a baseboard comprising a baseboard management controller on the baseboard;
at least one first motherboard connected to the baseboard, each of the at least one first motherboard comprising:
at least one first sensor used to sense the status of each of the at least one first motherboard; and
a signal-processing unit used to update a first status record according to the at least one first sensor; and
at least one second motherboard connected to the baseboard, each of the at least one second motherboard comprising:
at least one second sensor used to sense a status of each of the at least one second motherboard; and
a baseboard management controller on the motherboard used to update a second status record according to the at least one second sensor;
wherein the baseboard management controller on the baseboard is used to transmit a control signal to the signal-processing unit and the baseboard management controller on the motherboard for controlling the at least one first sensor and the at least one second sensor via the signal-processing unit and the baseboard management controller on the motherboard respectively, the first status record and the second status record are further transmitted to the baseboard management controller on the motherboard by the signal-processing unit and the baseboard management controller on the motherboard.

10. The system of claim 9, wherein the signal-processing unit is a peripheral interface controller (PIC).

11. The system of claim 9, wherein the signal-processing unit and the baseboard management controller on the motherboard communicate with the baseboard management controller on the baseboard via an inter-integrated circuit (I²C) interface.

12. The system of claim 9, wherein the control signal is in an intelligent platform management bus specification.
